(19) United States
(12) Patent Application Publication
(10) Pub. No.: US 2016/0128138 A1
(43) Pub. Date: May 5, 2016

(54) METHOD AND DEVICE FOR PROCESSING FROZEN FOOD

(71) Applicant: KONINKLIJKE PHILIPS N.V., Eindhoven (NL)

(72) Inventors: WEI LI, EINDHOVEN (NL); BIN YIN, EINDHOVEN (NL); DECLAN PATRICK KELLY, EINDHOVEN (NL)

(21) Appl. No.: 14/898,509

(22) PCT Filed: Jun. 18, 2014
(86) PCT No.: PCT/IB2014/062330

§ 371 Date: Dec. 15, 2015

(30) Foreign Application Priority Data
Jun. 28, 2013 (CN) PCT/CN2013/000786

(51) Int. Cl. H05B 6/68

(52) U.S. Cl. CPC H05B 6/688

(57) ABSTRACT

The present invention relates to a method of processing frozen food, the method comprising the steps of: applying a first thermal power to the frozen food; detecting a water phase change of the frozen food; and applying a second thermal power to the frozen food when the water phase change of the frozen food is detected. A device based on said method is also proposed. The method detects the water phase in food as the indicator of the thawing process, and can detect thawing progress through the change of this indicator. With the proposed method or device, the thawing progress of the frozen food can be controlled intelligently and more precisely.

### FIELD OF THE INVENTION

The invention relates to a method and a device for processing frozen food, in particular, to a method and a device for thawing frozen food.

### BACKGROUND OF THE INVENTION

Thawing frozen food is the process of heating the frozen food to above 0° C. For bulky and tough frozen food, such as meat, thawing is necessary for subsequent processing, including cutting and mincing. A suboptimal or even undesirable thawing outcome is expected in the case of a pre-defined power and time setting based on empirical models, due to the complexity of physical/chemical properties of food, e.g. shape, moisture content, ingredient composition. Local over or insufficient heating is often encountered in existing thawing processes. An ideal way is to control the power and time according to the real-time thawing state of food.

Even for food which does not need thawing and which can be directly cooked, such as French fries, this power control is useful also, because the optimal power setting of thawing process and cooking process can be different, and the power should be adjusted according to the state of the food. Inappropriate power control leads to bad taste and texture.

In current cooking/heating appliances, both power and time during the thawing process are controlled by a computer program, based on food type and weight. The food type is selected by the user, and the weight is defined by either the user or the weight sensor embedded in the cooking/heating appliance. This method achieves satisfying effects when the food contains only one or a few ingredients, and is close to an ‘average’ food item of this type (shape, composition). However, it fails when the food item differs too much from that.

For example, the proportion of muscle and fat in meat impacts the process of meat thawing, because the dielectric property of fat is different from that of muscle. In the microwave frequency band, a water molecule changes its direction according to the external electric field, and the friction caused by the rotation leads to electric energy loss in the form of heat. As muscle contains more water than fat, it can be heated faster than fat in a microwave oven. In reality, the complexity of food, even of the sample type, makes the intention of achieving proper thawing based on thawing models very unrealistic.

Power control based on food-state sensing during the thawing process in a cooking/heating appliance is not offered in currently available products in the market. Selecting an effective indicator for sensing the state of food is important. An obvious indicator is temperature, but it is difficult to judge the extent of thawing mainly because the internal and surface thawing states can be very different. For example, in airflow thawing systems and water thawing systems, heat is transferred from the surface to the inner part of the food item, and the temperature of the food item is difficult to detect, so that the inner part of the food item can be still frozen although the surface is at a high temperature. In microwave heating systems, food is heated more evenly, but the degree still varies from food type to food type. Besides, an infrared thermometer, which is widely used in temperature sensing, can only detect the surface temperature of food.

### SUMMARY OF THE INVENTION

It would thus be advantageous to provide a method and a device for processing frozen food more properly by selecting one or more suitable parameters, which reflect an actual food thawing state, not only the state at the surface, but also the state inside the food.

In the process of thawing food, the biggest change relates to the state of water in the food. In the frozen state, water in food is frozen to ice, and in the thawed state, ice melts to water. Water and ice differ very much in physical properties. This difference can be an indicator of a thawing process. Further, the power of a cooking/heating appliance can be controlled based on this indicator.

In order to address one or more of these concerns, an embodiment of the invention provides a method of processing frozen food, the method comprising the steps of: applying a first thermal power to the frozen food; detecting a water phase change of the frozen food; and applying a second thermal power to the frozen food when the water phase change of the frozen food is detected.

According to the proposed method, the water phase in food is detected as the indicator of the thawing process, and thawing progress can be detected through the change of this indicator. Said method controls the thawing progress by online detection of the food state, not based on an ‘average’ model of a certain food type.

This control method based on the real-time state of food is more precise, and largely avoids over-heating and insufficient heating resulting from thawing based on a generic model. Also, it saves energy compared to a traditional method, while over-heating can be avoided as desired.

Preferably, the step of detecting comprises: emitting one or more RF (radio frequency) signals towards the frozen food; receiving one or more RF signals which passed through the frozen food; and determining a water phase change according to first-order time derivative(s) of at least one predetermined parameter, wherein the at least one predetermined parameter represents the water phase of the frozen food.

Preferably, the at least one predetermined parameter comprises at least one of: the transmission coefficient of the one or more RF signals, which is the ratio of discrete Fourier transform of the received and emitted one or more RF signals; the dielectric constant of the frozen food, which is calculated using the following formula:

$${ɛ}^{′} \approx {( 1 + \frac{Δ Φ {λ}_{0}}{360 d} )}^{2}$$

wherein ε′ is the dielectric constant of the frozen food, ΔΦ is the phase shift of the calculated transmission coefficient of the one or more RF signals, λ₀ is the wavelength of the one or more RF signals in free space, and d is the penetration depth in the frozen food; and
the dielectric loss factor of the frozen food, which is calculated using the following formula:

$${ɛ}^{″} \approx \frac{Δ A {λ}_{0} \sqrt{{ɛ}^{′}}}{8.686 π d}$$

wherein ε″ is the dielectric loss factor of the frozen food; ΔA is the attenuation caused by the frozen food; and d is the penetration depth in the frozen food; and
said step of determining water phase change comprises: calculating the first-order time derivative(s) of the at least one parameter; and determining the water phase change when a jump of the first-order time derivative(s) is detected.

Optionally, the frequency of the one or more RF signals is within the microwave frequency band.

Optionally, the step of detecting comprises: detecting a water phase change of the frozen food in at least one direction.

Optionally, the second power is 0 or the same as the first thermal power.

A device for processing frozen food is proposed, the device comprising: a heating unit for applying a first thermal power to the frozen food; and a detecting unit for detecting a water phase change of the frozen food; wherein a second thermal power is applied to the frozen food when a water phase change of the frozen food is detected.

The proposed device detects the water phase in food as the indicator of the thawing process, and can detect thawing progress through the change of this indicator. It controls the thawing progress by online detection of the food state, not based on an ‘average’ model of a certain food type.

With such a configuration, the processing of frozen food based on the real-time state of food is more precise, and it largely avoids over-heating and insufficient heating resulting from thawing based on a generic model. Also, it saves energy compared to a traditional method while over-heating can be avoided as desired.

Preferably, the detecting unit comprises: an emitting antenna for emitting one or more RF signals towards the frozen food; a receiving antenna for receiving one or more RF signals which passed through the frozen food; and a calculating means for determining a water phase change according to one or more first-order time derivatives of at least one predetermined parameter, wherein the at least one predetermined parameter represents the water phase of the frozen food.

Preferably, the at least one predetermined parameter comprises at least one of:
the transmission coefficient of the one or more RF signals, which is the ratio of discrete Fourier transform of the received and emitted one or more RF signals;
the dielectric constant of the frozen food, which is calculated using the following formula:

$${ɛ}^{′} \approx {( 1 + \frac{Δ Φ {λ}_{0}}{360 d} )}^{2}$$

wherein ε′ is the dielectric constant of the frozen food, ΔΦ is the phase shift of the calculated transmission coefficient of the one or more RF signals, λ₀ is the wavelength of the one or more RF signals in free space, and d is the penetration depth in the frozen food; and
the dielectric loss factor of the frozen food, which is calculated using the following formula:

$${ɛ}^{″} \approx \frac{Δ A {λ}_{0} \sqrt{{ɛ}^{′}}}{8.686 π d}$$

wherein ε″ is the dielectric loss factor of the frozen food; ΔA is the attenuation caused by the frozen food; and d is the penetration depth in the frozen food; and
   determining a water phase change comprises: calculating one or more first-order time derivatives of at least one of the parameters; and determining the water phase change when a jump of the first-order time derivative(s) is detected.

Optionally, the frequency of the one or more RF signals is within the microwave frequency band.

Preferably, the detecting unit detects a water phase change of the frozen food in at least one direction.

Preferably, the device further comprises a container for containing the frozen food; at least one receiving antenna is placed under the bottom of the container; the emitting antenna is situated approximately opposite to the at least one receiving antenna.

Optionally, the second power is 0 or the same as the first thermal power.

What is also proposed is a microwave oven or a cooking appliance for processing frozen food, which comprises the abovementioned device.

These and other aspects of the invention will be apparent from and elucidated with reference to the embodiments described hereinafter. However, the invention is not limited to these exemplary embodiments.

### BRIEF DESCRIPTION OF THE DRAWINGS

The present invention will now be described based on various embodiments and with reference to the accompanying drawings, in which:

FIG. 1 shows a schematic diagram of a device according to an embodiment of the invention;

FIG. 2 shows an example control sequence according to an embodiment of the invention;

FIG. 3 shows a schematic diagram of an experimental setup according to an embodiment of the invention;

FIG. 4 shows the transmission coefficient of the samples during the thawing process;

FIG. 5 shows the dielectric constant of the samples during the thawing process;

FIG. 6 shows the dielectric loss factor of the samples during the thawing process.

### DETAILED DESCRIPTION OF THE INVENTION

Reference will now be made to embodiments of the disclosure, one or more examples of which are illustrated in the figures. The embodiments are provided by way of explanation of the disclosure, and are not meant as a limitation of the disclosure. For example, features illustrated or described as part of one embodiment may be used with another embodiment to yield a still further embodiment. It is intended that the disclosure encompass these and other modifications and variations as come within the scope and spirit of the disclosure.

The term “frozen food” herein refers to all kinds of food which is frozen or in refrigerated storage.

The term “thermal power” herein refers to microwave power, infrared power, other types of thermal radiation and/or any types of thermal conductivity.

The term “water phase” herein refers to the states of water, such as liquid state, solid state or gaseous state.

The basis of the proposed method is detection of a water phase. The ice in food changes to water when the food thaws, and the dielectric property of ice is substantially different from that of water. The thermal power of a cooking/heating appliance thus can be adjusted according to the state of food during thawing.

The electromagnetic power dissipated per unit volume can be expressed by

P=55.63fε″E²*10⁻¹² W/m³ (1)
wherein E represents the root mean square (RMS) electric field intensity in V/m, which is dependent on the dielectric constant ε′. The dielectric constant ε′ depends on the geometry and the electric field configuration.

At a microscopic level, food dielectric behavior is dominated by several dielectric mechanisms. In RF frequencies, dipole orientation and ionic conduction interact strongly. Equation (2) gives the constituents of a loss factor ε″. The first item of the second part of the equation is caused by rotation of dipole, and the second item is associated with the conductivity of food ingredients.

ε″≦ε″_{d}+σ/ε₀ω (2)
wherein ε″_{d} is the loss factor due to dipole rotation; σ is the ionic conductivity in Sm⁻¹ of the material; ε₀ is the absolute permittivity of a vacuum; ω is the angular frequency=2πf; and f is the frequency of RF.

A water molecule is polar, which means it can adjust its direction according to an external electric field. The rotation of dipole transforms the electromagnetic energy to heat, resulting in energy loss.

The thawing process contains three stages: ice, mixture of ice and water, water. In the frozen state, water molecules in food are nearly fixed, which means it is difficult to cause them to rotate by applying an external electric field. The main contribution to ε″ is ionic conduction. When food is heated to 0° C., ice changes to liquid water, and water molecules are set free. The rotation of free water molecules causes an electromagnetic energy loss (associated with ε″); also the electric field distribution in water changes (associated with ε′), as a result, the dielectric property of food changes. 0° C. is the critical point in the food thawing process. It is also the turning point in the dielectric property change of food. Therefore, the food thawing process can be detected through dielectric property sensing.

According to an embodiment of the invention, a method of processing frozen food comprises the steps of:
applying a first thermal power to the frozen food;
detecting a water phase change of the frozen food; and
applying a second thermal power to the frozen food when the water phase change of the frozen food is detected.

Preferably, the step of detecting is performed continuously during applying the first thermal power to the frozen food, so that the water phase (and therefore the water phase change) can be detected in real time.

The proposed method detects a water phase (i.e. liquid or solid state of water) in food as the indicator of a thawing process, and can detect thawing progress through the change of this indicator. It controls the thawing progress by online detection of the food state, not based on an ‘average’ model of a certain food type.

Such a control method based on the real-time state of food is more precise, and substantially avoids over-heating and insufficient heating resulting from thawing based on a generic model. Also, it saves energy compared to a traditional method, while over-heating can be avoided as desired.

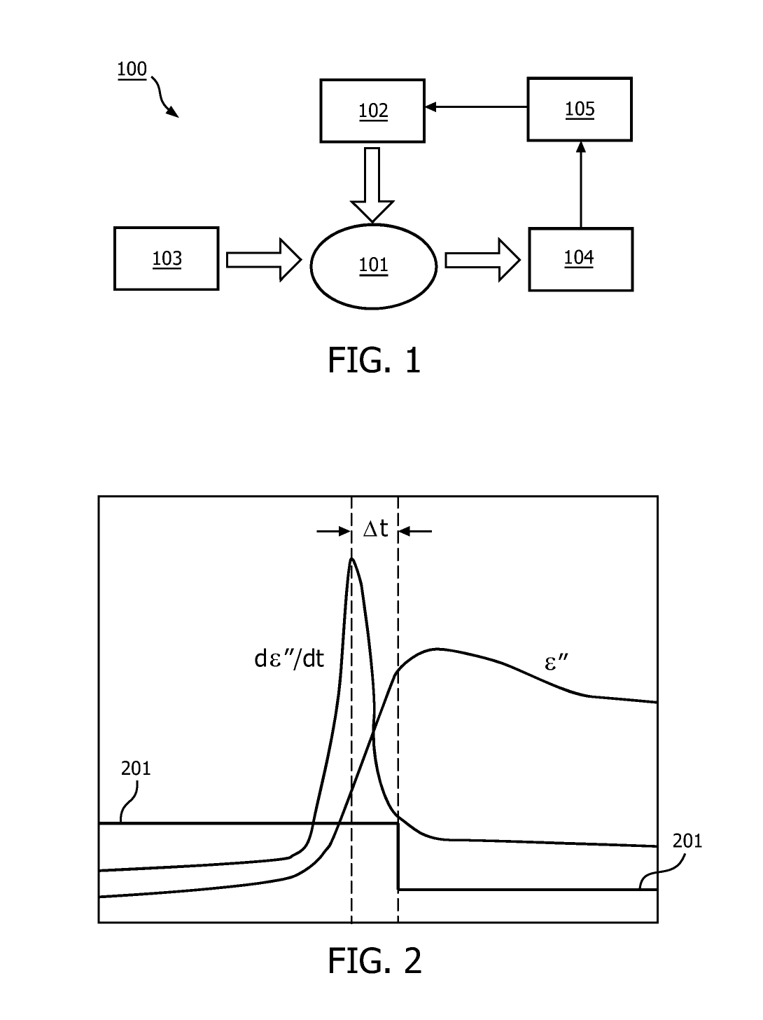

FIG. 1 shows a schematic diagram of a device according to an embodiment of the invention. The device processes the frozen food using the methods according to various embodiments of the invention.

As shown in FIG. 1, the device 100 for processing frozen food 101 comprises: a heating unit 102 for applying a first thermal power to the frozen food 101; and a detecting unit for detecting a water phase change of the frozen food; wherein a second thermal power is applied to the frozen food when a water phase change of the frozen food is detected.

The thermal power can be in the form of microwave energy, infrared energy, other types of thermal radiation and/or any types of thermal conductivity, which can process (e.g. thaw, heat, or cook etc.) food as desired.

The device detects a water phase in food as the indicator of a thawing process, and can detect thawing progress through the change of this indicator. It controls the thawing progress by online detection of the food state, not based on an ‘average’ model of a certain food type.

According to a preferred embodiment of the invention, the detecting unit comprises: an emitting antenna 103 for emitting one or more radio frequency (RF) signals towards the frozen food 101; a receiving antenna 104 for receiving said one or more RF signals which passed through the frozen food 101; and a calculating means 105 for determining a water phase change according to first-order time derivative(s) of at least one predetermined parameter, wherein the at least one predetermined parameter represents the water phase of the frozen food.

Optionally, said at least one predetermined parameter comprises at least one of: the transmission coefficient (S₂₁) of the one or more RF signals, which is the ratio of discrete Fourier transform of the received and emitted one or more RF signals; the dielectric constant of the frozen food, which is calculated using the following formula:

$${ɛ}^{′} \approx {( 1 + \frac{Δ Φ {λ}_{0}}{360 d} )}^{2} \qquad ( 3 )$$

wherein ε′ is the dielectric constant of the frozen food, ΔΦ is the phase shift of the calculated transmission coefficient of the one or more RF signals, λ₀ is the wavelength of the one or more RF signals in free space, and d is the penetration depth in the frozen food; and
the dielectric loss factor of the frozen food, which is calculated using the following formula:

$${ɛ}^{″} \approx \frac{Δ A {λ}_{0} \sqrt{{ɛ}^{′}}}{8.686 π d} \qquad ( 4 )$$

wherein ε″ is the dielectric loss factor of the frozen food; ΔA is the attenuation caused by the frozen food; and d is penetration depth in the frozen food;
said step of determining a water phase change comprises:
   calculating one or more first-order time derivatives of at least one of the parameters; and
   determining the water phase change when a jump of the first-order time derivative(s) is detected.

The frequency which can be used to detect dielectric properties of a material is RF (covering a wide frequency band, 3 KHz˜300 GHz), including 2.45 GHz used in a microwave oven. Optionally, the frequency of the one or more RF signals for detection is within the microwave frequency band. The dielectric property can be used to describe a change in water phase.

Various methods e.g. transmission/reflection line method, open ended coaxial probe method, free space method, resonant method, can be used to detect the dielectric property of food. A free space method is preferred for the present invention because it is easy to integrate in a cooking/heating appliance.

Dielectric parameters, e.g. S₁₁, S₂₁, ε′, and ε″, can be used to describe the dielectric property of food. Transmission coefficient S₂₁, dielectric constant ε′ and dielectric loss factor ε″ are preferred for the present invention. Among them, ε′ and ε″ are more preferred, since they take specific properties of the food into account as can be seen from formulas (3) and (4).

According to a preferred embodiment of the invention, the detecting unit detects a water phase change of the frozen food in at least one direction. In such a way, the state of water in the frozen food can be determined generally and more precisely.

Preferably, the device can further comprise a container for containing the frozen food; at least one receiving antenna is placed under the bottom of the container; the emitting antenna is approximately opposite to the at least one receiving antenna. With such a configuration, the state of water in the frozen food can be determined generally and more precisely. Optionally, said at least one receiving antenna corresponds to the center of the bottom, such that the frozen food is apt to be detected according to its location.

According to a preferred embodiment of the invention, the second power is 0 or the same as the first thermal power. The frozen food can be processed manually after thawing (which means the first thermal power should be shut down), or, it can be further processed with a preset power level (i.e. the second thermal power) for a period of time as desired.

FIG. 2 shows an example control sequence according to an embodiment of the invention. In FIG. 2, the horizontal axis indicates time. The large change of the dielectric parameters of food during thawing can help control the thawing process of food in a cooking/heating appliance. The level profile of the heating power can be determined based on the change of dielectric parameters. One possibility is to transform the detected dielectric parameters into a control parameter of the cooking/heating appliance power.

One possible control strategy is shown in FIG. 2. The control parameter (as indicated with reference sign 201) is set to ‘on’ when S₂₁ is high or ε″ is low in the frozen state. When a jump/transition in dielectric parameter is detected according to the first derivative, a timer starts. When the timer reaches Δt, in order to cause food to thaw completely, the control parameter is set to ‘off’, which means the thawing process is finished. The value of Δt can be adjusted according to the different cooking/heating appliances.

A microwave oven or cooking appliance comprising the device according to the foregoing embodiments of the invention can also be used advantageously for processing frozen food.

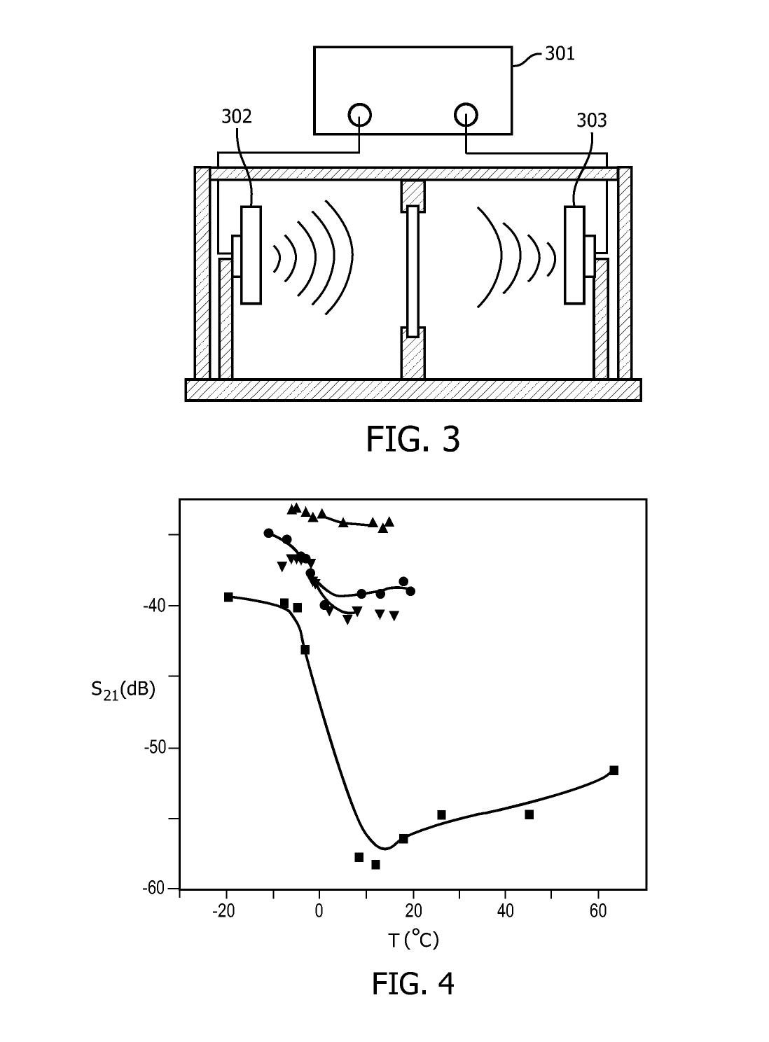

FIG. 3 shows a schematic diagram of an experiment setup according to an embodiment of the invention. The vector network analysis (VNA) 301 is used as the signal generator and receiver. Copper antennas 302, 303 (f=2.4 GHz) are used in the setup. Water, apple, potato, and meat samples are used. They are cut to slices with a thickness of 1 cm and a width larger than that of antennas. Then they are frozen in a refrigerator for one day. The thawing process is completed by an airflow method. The frequency used to calculate dielectric parameters is 2.45 GHz, which is the same as used in most microwave ovens. The temperature is measured by thermocouple whose probe is placed in the core of food.

FIGS. 4-6 show the transmission coefficient, the dielectric constant and the dielectric loss factor of the samples, respectively, during the thawing process, which is performed by the experiment setup as shown in FIG. 3. In FIGS. 4-6, the squares indicate corresponding values of water; the circles indicate corresponding values of apple; the triangles indicate corresponding values of potato; and the inverted triangles indicate corresponding values of meat.

In FIG. 4, the horizontal axis is temperature, which represents the stage of a thawing process; the vertical axis is 20 log|S₂₁|.

Taking water as an example, in the state of ice, the rotation of the water molecule dipole is not active, so the transmission rate is high, which leads to a high 20 log|S₂₁| value (near −40). In the state of water, the water molecule is free, and it can rotate with the external electric field, which results in lower 20 log|S₂₁| (between −50 to −60). Upon a phase transition, a jump in 20 log |S₂₁| happens. This jump corresponds to the phase change of water during the thawing process. Therefore, the ice thawing process can be described by this jump.

The food thawing process is similar to the ice thawing process because the main change in food dielectric property during thawing is caused by the phase change of ice. Accordingly, a similar trend is also observed in the food thawing process (apple, potato and meat). The jump in 20 log|S₂₁| near 0° C. can be the indicator of completion of a food thawing process.

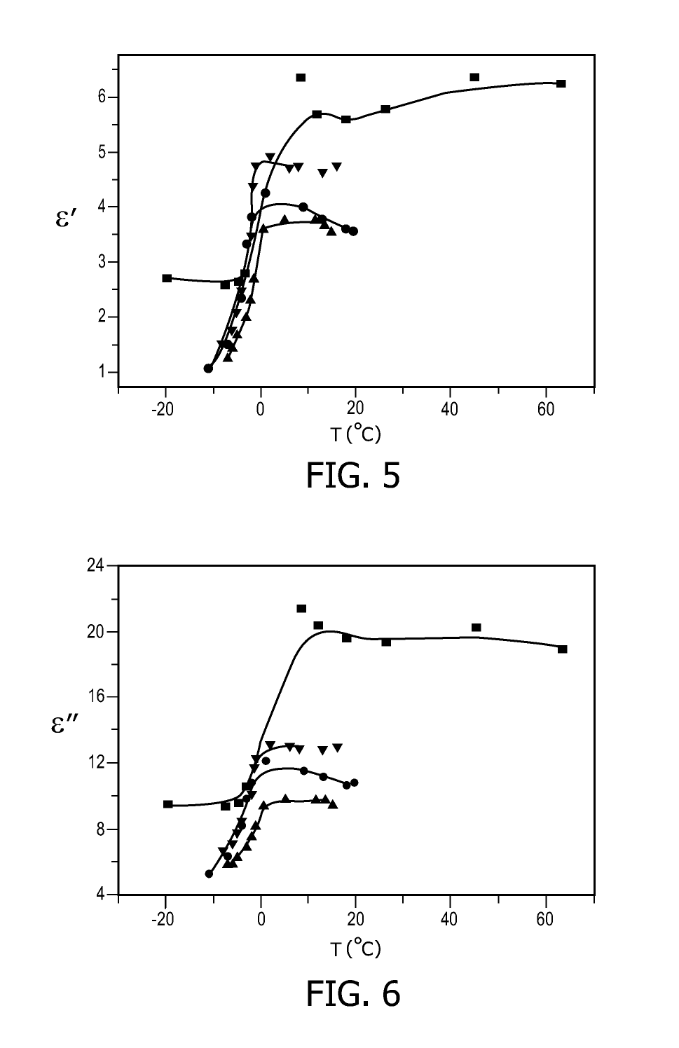

Further, in FIGS. 5 and 6, the horizontal axis is temperature, which represents the stage of a thawing process; the vertical axis indicates ε′ and ε″ respectively in arbitrary units.

The values of ε′ and ε″ at low temperatures are low because the free water is frozen to ice. A sharp increase in ε′ and ε″ is observed in the melting zone. The jump point is near 0° C., which is associated with a phase change point of water. It indicates the dielectric constant and the loss factor, which also can be used for sensing a food thawing process.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A method of processing frozen food, the method comprising the steps of:
applying a first thermal power to the frozen food;
detecting a water phase change of the frozen food; and
applying a second thermal power to the frozen food when a water phase change of the frozen food is detected.
wherein the step of detecting comprises:
emitting one or more RF signals towards the frozen food;
receiving one or more RF signals which passes through the frozen food; and
determining a water phase change when a jump of one or more first-order time derivative of the intrinsic dielectric property of frozen food is detected.

2. (canceled)

3. The method according to claim 2, wherein the intrinsic dielectric property is the dielectric loss factor of the frozen food, which is calculated using the following formula:
$${ɛ}^{″} \approx \frac{Δ A {λ}_{0} \sqrt{{ɛ}^{′}}}{8.686 π d}$$
wherein ε″ is the dielectric loss factor of the frozen food; ΔA is the attenuation caused by the frozen food; and d is the penetration depth in the frozen food.

4. The method according to claim 2, wherein the frequency of the one or more RF signals is within the microwave frequency band.

5. The method according to claim 1, wherein the step of detecting comprises:
detecting a water phase change of the frozen food in at least one direction.

6. The method according to claim 1, wherein the second power is 0 or the same as the first thermal power.

7. A device for processing frozen food, the device comprising:
a heating unit for applying a first thermal power to the frozen food; and
a detecting unit for detecting a water phase change of the frozen food;
wherein a second thermal power is applied to the frozen food when a water phase change of the frozen food is detected;
wherein the detecting unit comprises:
an emitting antenna for emitting one or more RF signals towards the frozen food;
a receiving antennas for receiving one or more RF signal which passed through the, frozen food; and
a calculating means for determining a water phase change when a jump of one or more first-order time derivatives of the intrinsic dielectric property of the frozen food is detected.

8. (canceled)

9. The device according to claim 8, wherein the intrinsic dielectric property is the dielectric loss factor of the frozen food, which is calculated using the following formula:
$${ɛ}^{″} \approx \frac{Δ A {λ}_{0} \sqrt{{ɛ}^{′}}}{8.686 π d}$$
wherein ε″ is the dielectric loss factor of the frozen food; ΔA is the attenuation caused by the frozen food; and d is the penetration depth in the frozen food.

10. The device according to claim 8, wherein the frequency of the one or more RF signals is within the microwave frequency band.

11. The device according to claim 7, wherein the detecting unit detects a water phase change of the frozen food in at least one direction.

12. The device according to claim 11, wherein the device further comprises a container for containing the frozen food; at least one receiving antenna is placed under the bottom of the container; the emitting antenna is approximately opposite to the at least one receiving antenna.

13. The device according to claim 7. wherein the second power is 0 or the same as the first thermal power.

14. A microwave oven, which microwave oven comprises the device for processing frozen food according to claim 7.

15. A cooking appliance, which cooking appliance comprises the device for processing frozen food according to claim 7.

16. The method according to claim 1, wherein the intrinsic dielectric property is the dielectric constant of the frozen food, which is calculated using the following formula:
$${ɛ}^{′} \approx {( 1 + \frac{Δ Φ {λ}_{0}}{360 d} )}^{2}$$
wherein ε′ is the dielectric constant of the frozen food, ΔΦ is the phase shift of the, calculated transmission coefficient of the one, or more RF signals, λ₀ is the wavelength of the one or more RF signals in free space, and, d is the penetration depth in the frozen food.

17. The device according to claim 7, wherein the intrinsic dielectric property is the dielectric constant of the frozen food, which is calculated using the following formula:
$${ɛ}^{′} \approx {( 1 + \frac{Δ Φ {λ}_{0}}{360 d} )}^{2}$$
wherein ε′ is the dielectric constant of the frozen food, ΔΦ is the phase shift of the calculated transmission coefficient of the one, or more RF signals, λ₀ is the wavelength of the one or more RF signals in free space, and, d is the penetration depth in the frozen food.
